(19) United States
(12) Patent Application Publication
(10) Pub. No.: US 2026/0368352 A1
(43) Pub. Date: Nov. 19, 2026

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventor: Tetsuro HOSHINO, Tokyo (JP)

(73) Assignee: NEC Corporation, Minato-ku, Tokyo (JP)

(21) Appl. No.: 19/124,341

(22) PCT Filed: Nov. 14, 2022
(86) PCT No.: PCT/JP2022/042222

§ 371 Date: Apr. 25, 2025

(51) Int. Cl. G06F 21/62; G06T 5/77; G06V 40/16; G06V 40/50

(52) U.S. Cl. CPC G06F 21/6245; G06T 5/77; G06V 40/172; G06V 40/50; G06T 2207/30201

(57) ABSTRACT

An information processing apparatus includes: a processing unit that adds or deletes a retouch for a person area including a predetermined part of a person in an image; an identification unit that identifies a person corresponding to the person area, by using the person area; and a determination unit that determines whether or not a viewer who views the image is permitted to view the identified person identified by the identification unit, wherein the processing unit deletes the retouch for the person area, in response to a determination by the determination unit that the viewer is permitted to view the identified person, and the processing unit adds the retouch for the person area, in response to a determination by the determination unit that the viewer is not permitted to view the identified person.

### TECHNICAL FIELD

This disclosure relates to technical fields of an information processing apparatus, an information processing system, an information processing method, and a recording medium.

### BACKGROUND ART

Patent Literature 1 describes a technology/technique of: receiving a setting instruction as to whether or not to allow a user's face image to be published on a social networking service; and performing mosaic processing on a face portion according to the setting instruction, wherein the setting instruction specifies one of always publication permission/always publication refusal/advance inquiry.

Patent Literature 2 describes a technology/technique in which when predetermined information is recognized in uploaded information data, and when the recognized predetermined information is compared with stored data in a terminal information database and the predetermined information in the information data is determined to match predetermined information included in unique data, a notification means for inquiring whether or not to permit the disclosure of the uploaded information data, is created, and the notification means is transmitted to a specific terminal device.

Patent Literature 3 describes a technology/technique of: storing an image and a disclosure range setting of the image in a virtual memory region for each user; allowing a user to reproduce an image in accordance with a disclosure range of an image; setting association between a face region and a user for each image; allowing each user to set a disclosure range of his/her face information; detecting a feature quantity with respect to each user from the face information associated with each user and specifying a person in an image; deciding one or plural disclosure range settings in accordance with persons in an image and the relation between them; and generating an image for each decided disclosure range.

Patent Literature 4 describes a technology/technique for image publishing sites. According to a technology/technique described in Patent Literature 4, face images of a user himself/herself who uploads an image and a desired person are registered in advance as a face image of the user himself/herself and a face image for collation. An input of an original image to be uploaded with an URL of an upload destination site is received from a user terminal, and it is determined whether to disclose or not disclose each of the face images included in the original image in accordance with a disclosure condition of the upload destination site registered in a disclose condition database. At this time, a face image determined to be the same person as the face image of the user himself/herself or the face image for collation, serving as a target of disclosure, is left as it is, and the other face image is processed such that the person cannot be identified. Then, a disclosed image is generated and uploaded to a disclosed image database.

Patent Literature 5 describes a technology/technique of: acquiring environmental information on an area where display means is present; calculating a restriction degree that indicates a degree of display restriction on display information displayed on the display means on the basis of the environmental information; and restricting the display of the display information on the basis of the restriction degree.

Patent Literature 6 describes a technology/technique of: being connected with a web server for disclosing content posted from a user terminal through a network; receiving content which is an object of disclosure determination; storing disclosure conditions for permitting disclosure of information included in the content; determining propriety of disclosure of information included in the content received by using the disclosure conditions; and transmitting, to the web server, the information which is permitted among the information included in the content received.

### CITATION LIST

### Patent Literature

Patent Literature 1: JP2021-002116A
Patent Literature 2: JP2019-079143A
Patent Literature 3: JP2016-167170A
Patent Literature 4: JP2015-222460A
Patent Literature 5: JP2015-103020A
Patent Literature 6: JP2014-238635A

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: a processing unit that adds or deletes a retouch for a person area including a predetermined part of a person in an image; an identification unit that identifies a person corresponding to the person area, by using the person area; and a determination unit that determines whether or not a viewer who views the image is permitted to view the identified person identified by the identification unit, wherein the processing unit deletes the retouch for the person area, in response to a determination by the determination unit that the viewer is permitted to view the identified person, and the processing unit adds the retouch for the person area, in response to a determination by the determination unit that the viewer is not permitted to view the identified person.

An information processing method according to an example aspect includes: adding or deleting a retouch for a person area including a predetermined part of a person in an image; identifying a person corresponding to the person area, by using the person area; determining whether or not a viewer who views the image is permitted to view the identified person identified by using the person area; deleting the retouch for the person area, in response to a determination that the viewer is permitted to view the identified person; and adding the retouch for the person area, in response to a determination that the viewer is not permitted to view the identified person.

A recording medium according to an example aspect is a recording medium on which a computer program that allows a computer to execute an information processing method is recorded, the information processing method including: adding or deleting a retouch for a person area including a predetermined part of a person in an image; identifying a person corresponding to the person area, by using the person area; determining whether or not a viewer who views the image is permitted to view the identified person identified by using the person area; deleting the retouch for the person area, in response to a determination that the viewer is permitted to view the identified person; and adding the retouch for the person area, in response to a determination that the viewer is not permitted to view the identified person.

### BRIEF DESCRIPTION OF DRAWINGS

FIG. 1 is a block diagram illustrating a configuration of an information processing apparatus in a first example embodiment.

FIG. 2 is a block diagram illustrating a configuration of an information processing apparatus in a second example embodiment.

FIG. 3 is a conceptual diagram illustrating an information processing operation of the information processing apparatus in the second example embodiment.

FIG. 4 is a flowchart illustrating a flow of the information processing operation of the information processing apparatus in the second example embodiment.

FIG. 5 is a conceptual diagram illustrating a user interface provided by the information processing apparatus in the second example embodiment.

FIG. 6 is a flowchart illustrating a flow of the information processing operation of the information processing apparatus in the second example embodiment.

FIG. 7 is a flowchart illustrating a flow of the information processing operation of the information processing apparatus in the second example embodiment.

FIG. 8 is a block diagram illustrating a configuration of an information processing apparatus in a third example embodiment.

FIG. 9 is a conceptual diagram illustrating an information processing operation of the information processing apparatus in the third example embodiment.

FIG. 10 is a flowchart illustrating a flow of the information processing operation of the information processing apparatus in the third example embodiment.

FIG. 11 is a block diagram illustrating a configuration of an information processing apparatus in a fourth example embodiment.

FIG. 12 is a conceptual diagram of a user interface provided by the information processing apparatus in the fourth example embodiment.

FIG. 13 is a flowchart illustrating a flow of an information processing operation of the information processing apparatus in the fourth example embodiment.

FIG. 14 is a conceptual diagram of the user interface provided by the information processing apparatus in the fourth example embodiment.

FIG. 15 is a conceptual diagram of the user interface provided by the information processing apparatus in the fourth example embodiment.

FIG. 16 is a block diagram illustrating a configuration of an information processing apparatus in a fifth example embodiment.

FIG. 17 is a flowchart illustrating a flow of an information processing operation of the information processing apparatus in the fifth example embodiment.

### DESCRIPTION OF EXAMPLE EMBODIMENTS

Hereinafter, with reference to the drawings, an information processing apparatus, an information processing method, and a recording medium according to example embodiments will be described.

### 1: First Example Embodiment

An information processing apparatus, an information processing method, and a recording medium according to a first example embodiment will be described. The following describes the information processing apparatus, the information processing method, and the recording medium according to the first example embodiment, by using an information processing apparatus 1 to which the information processing apparatus, the information processing method, and the recording medium according to the first example embodiment are applied.

### [1-1: Configuration of Information Processing Apparatus 1]

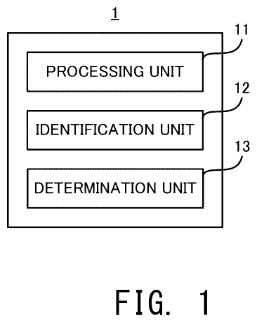

FIG. 1 is a block diagram illustrating a configuration of the information processing apparatus 1 in the first example embodiment. As illustrated in FIG. 1, the information processing apparatus 1 includes a processing unit 11, a identification unit 12, and a determination unit 13.

The processing unit 11 adds or deletes a retouch/editing for a person area including a predetermined part of a person in an image. The identification unit 12 identifies the person corresponding to the person area, by using the person area. The determination unit 13 determines whether or not a viewer of the image is permitted to view the identified person identified by the identification unit 12. When the determination unit 13 determines that the viewer is permitted to view the identified person, the processing unit 11 deletes the retouch for the person area. When the determination unit 13 determines that the viewer is not permitted to view the identified person, the processing unit 11 adds the retouch for the person area. 30

### [1-2: Technical Effect of Information Processing Apparatus 1]

The information processing apparatus 1 in the first example embodiment does not add the retouch to the identified person who permits being viewed, but adds the retouch to the identified person who does not permits being viewed, and it is therefore possible to properly protect privacy.

### 2: Second Example Embodiment

Next, an information processing apparatus, an information processing method, and a recording medium according to a second example embodiment will be described. The following describes the information processing apparatus, the information processing method, and the recording medium according to the second example embodiment, by using an information processing apparatus 2 to which the information processing apparatus, the information processing method, and the recording medium according to the second example embodiment are applied.

### [2-1: Person Using Information Processing Apparatus 2]

The information processing apparatus 2 may provide a service for allowing a person to view photographs. The information processing apparatus 2 may provide a service for allowing a person to view photographs stored in a photograph storage unit 221.

The person who uses the information processing apparatus 2 may include an administrator and a user. The administrator may include a person who manages/administrates the operation of the information processing apparatus 2. The administrator may include a person who manages/administrates the service provided by the information processing apparatus 2. The administrator may include a person who is involved in management of a school. There may be one or more administrators. The administrator may include a person who is involved in management of an organization. The organization may include groups with needs of sharing photographs of participants in hobbies and sports, such as soccer, baseball, judo, and karate. These groups may be local groups, or the like. The organization may also include groups such as boy scouts and girl scouts. The administrator may include a person, a group, or a corporation that is entrusted with photographing by the person who manages/administrates the operation of the information processing apparatus 2, the person who manages/administrates the service provided by the information processing apparatus 2, the person who is involved in management of a school, or the person who is involved in management of an organization.

The user may be a person who uses the service provided by the information processing apparatus 2. The user may include a student of the above-described school and his/her guardian/parent(s). The user may include a resident of a school district of the above-described school. The user may include a member of the above-described organization. The user may include a person in the photograph. The user may include a person who takes the photograph.

### [2-2: Configuration of Information Processing Apparatus 2]

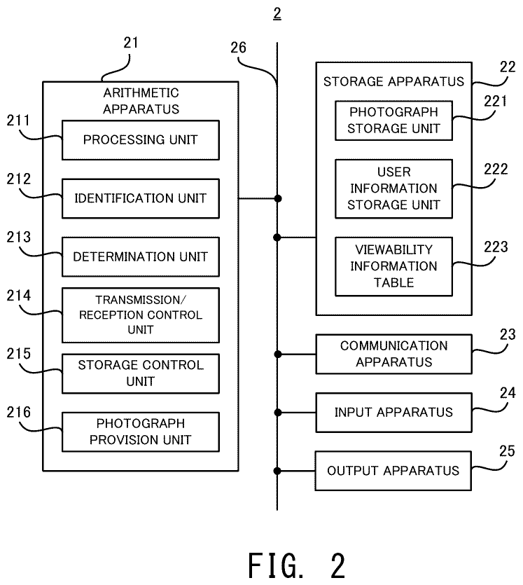

FIG. 2 is a block diagram illustrating a configuration of the information processing apparatus 2 in the second example embodiment. As illustrated in FIG. 2, the information processing apparatus 2 includes an arithmetic apparatus 21 and a storage apparatus 22. Furthermore, the information processing apparatus 2 may also include a communication apparatus 23, an input apparatus 24, and an output apparatus 25. The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes, for example, at least one of a CPU (central processing unit), a GPU (graphics processing unit), and an FPGA (field programmable gate array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-transitory recording medium, by using a not-illustrated recording medium reading apparatus provided in the information processing apparatus 2 (e.g., the input apparatus 24 described later). The arithmetic apparatus 21 may acquire (in other words, download or read) a computer program from a not-illustrated apparatus disposed outside the information processing apparatus 2, via the communication apparatus 23 (or another communication apparatus). The arithmetic apparatus 21 executes the read computer program. Consequently, a logical functional block for performing an operation to be performed by the information processing apparatus 2 is realized in the arithmetic apparatus 21. That is, the arithmetic apparatus 21 is allowed to function as a controller for realizing the logical functional block for performing an operation (or, in other words, processing) to be performed by the information processing apparatus 2.

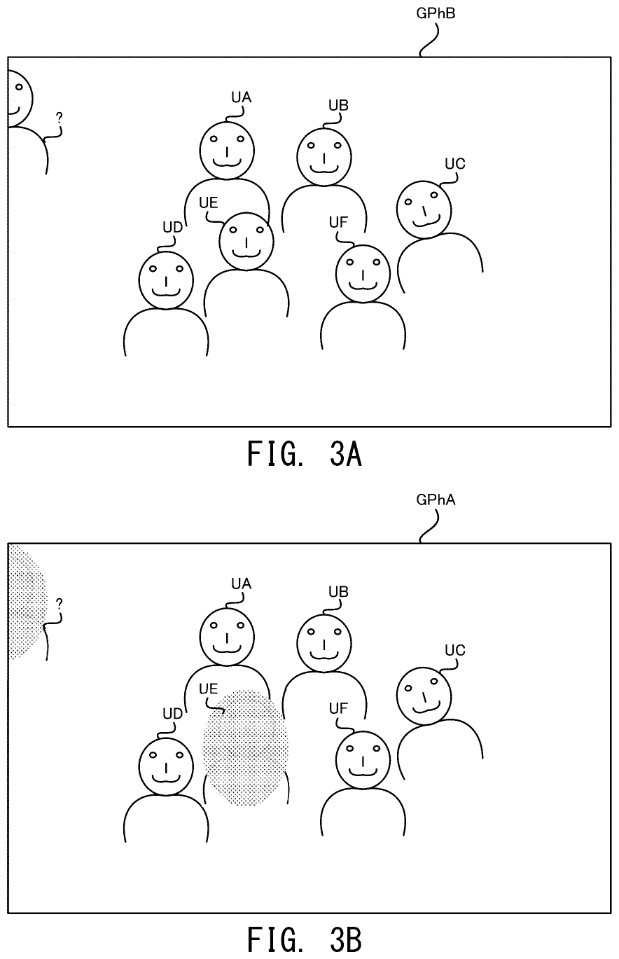

FIG. 2 illustrates an example of the logical functional block realized in the arithmetic apparatus 21 in order to perform an information processing operation. As illustrated in FIG. 2, a processing unit 211 that is a specific example of the “processing unit” described later in Supplementary Notes, an identification unit 212 that is a specific example of the “identification unit” described later in Supplementary Notes, a determination unit 213 that is a specific example of the “determination unit” described later in Supplementary Notes, a transmission/reception control unit 214 that is a specific example of the “viewability information receiving unit” described later in Supplementary Notes, a storage control unit 215, and a photograph provision unit 216 are realized in the arithmetic apparatus 21. However, any one of the transmission/reception control unit 214, the storage control unit 215, and the photograph provision unit 216 may not be realized in the arithmetic apparatus 21. Details of operation of each of the processing unit 211, the identification unit 212, the determination unit apparatus 213, the transmission/reception control unit 214, the storage control unit 215, and the photograph provision unit 216 will be described later with reference to FIG. 3.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored for a long time by the information processing apparatus 2. The storage apparatus 22 may include at least one of a random access memory (RAM), a read-only memory (ROM), a hard disk apparatus, a magneto-optical disk apparatus, a solid state drive (SSD), and a disk array apparatus. That is, the storage apparatus 22 may include a non-transitory recording medium. The storage apparatus 22 may realize a photograph storage unit 221, a user information storage unit 222, and a viewability information table 223 that is a specific example of the “storage unit” described later in Supplementary Note. However, the storage apparatus 22 may not realize any one of the photograph storage unit 221, the user information storage unit 222, and the viewability information table 223.

The communication apparatus 23 is configured to communicate with an apparatus external to the information processing apparatus 2 via a not-illustrated communication network. The communication apparatus 23 may be a communication interface based on standards such as Ethernet (registered trademark), Wi-Fi (registered trademark), Bluetooth (registered trademark), and USB (Universal Serial Bus).

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that is externally attachable to the information processing apparatus 2.

The output apparatus 25 is an apparatus that outputs information to the outside of the information processing apparatus 2. For example, the output apparatus 25 may output information as an image. That is, the output apparatus 25 may include a display apparatus (a so-called display) that is configured to display an image indicating the information that is desirably outputted. In other words, in the second example embodiment, the information processing apparatus 2 includes a display D as the output apparatus 25. For example, the output apparatus may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a printing apparatus (a so-called printer) that is configured to print desired information on the paper surface.

### [2-3: Information Processing Operation Performed by Information Processing Apparatus 2]

### [2-3-1: Storage of Photographs]

The photograph storage unit 221 stores therein photographs that the information processing apparatus 2 allows the administrator and the user to view. The administrator and the user may be able to upload photographs to the photograph storage unit 221. For example, the photograph storage unit 221 may store therein photographs of events in which users have participated together, such as sports day.

### [2-3-2: Registration of User]

By performing a registration operation on the information processing apparatus 2, a person himself may become the user of the information processing apparatus 2. A person who wishes to use the apparatus may become the user of the information processing apparatus 2, by submitting a request for registration. At the time of registration, the information processing apparatus 2 may request the person to consent to an arrangement or the like regarding the use of the information processing apparatus 2. The information processing apparatus 2 may register a person who consents to the service provided by the information processing apparatus 2, as the user. On the other hand, the information processing apparatus 2 may not register a person who does not consent to the service provided by the information processing apparatus 2, as the user.

At the time of registration, the information processing apparatus 2 may request the person to register a face image. The face image may be used for logging in to the service provided by the information processing apparatus 2.

The person may perform the registration operation, by connecting to the information processing apparatus 2 from a terminal apparatus that is usable by the person and operating the terminal apparatus. The terminal apparatus may be an apparatus that is connectable to the information processing apparatus 2 via the Internet, such as a personal computer and a smartphone.

For example, in a case where a photograph of a person, who wishes to use the service provided by the information processing apparatus 2, is stored in the photograph storage unit 221 when the person submits the request for registration, the person may be registered as the user. In addition, in the case of a person satisfying a predetermined condition, such as being a member of an organization, being a student of a school, being a guardian of a student, or being a resident of a school district, the person may be registered as the user. Alternatively, in a case where the administrator gives permission, the person may be registered as the user.

Alternatively, the administrator may collectively register face images that are collected in advance, and may collectively register persons corresponding to the registered face images, as the users. For example, the administrator may collectively register the users, by a unit of a school or the like.

Information on the registered users may be stored in the user information storage unit 222. The user information storage unit 222 may store therein the user's name, face image, contact details, and the like, as the information on the user.

### [2-3-3: Retouch]

The processing unit 211 adds or deletes a retouch/editing for a person area including a predetermined part of a person in a photograph. The predetermined part of the person may be a part of the person that allows identification of an individual. The predetermined part of the person may be a face. The predetermined part of the person may be a part above shoulders. The predetermined part of the person may be a part above a chest. The person area includes at least the predetermined part of the person. The person area may be an image area of the person included in the photograph. The person area may be an area including a part of the person. The person area may include an area that allows identification of the person, such as his/her physique and clothing. The person area may be an area including an entire body of the person.

Adding the retouch may be superimposing severe blurring to the extent that an individual cannot be identified. In addition, adding the retouch may be superimposing a background image or the like that is generated or acquired in accordance with the photograph. The person without the retouch may appear as if the person were not captured in the photograph.

The identification unit 212 identifies the user corresponding to the person area included in the photograph, by using the person area. The identification unit 212 may identify the user corresponding to the person area included in the photograph, by using face authentication using a face area included in the person area. In addition, the identification unit 212 may identify the user by using other features, such as appearance, other than the user's face. The identification unit 212 may identify the user, based on the time and location in which the photograph is taken. The determination unit 213 determines whether or not a user UB who is a viewer of the photograph is permitted to view a user UA who is an identified person identified by the identification unit 212. The identified person may mean a user captured in the photograph.

When the determination unit 213 determines that the user UB is permitted to view the user UA, the processing unit 211 deletes the retouch for the person area. In the present example embodiment, deleting the retouch means setting the image unretouched. The retouch may be irreversible. That is, it may be hardly possible to restore the image that is once retouched, to the unretouched image. In this case, for example, the photograph storage unit 221 may retain an uploaded image without the retouch, and when deleting the retouch, the processing unit 211 may set an image unretouched by using the retained image without the retouch. Retaining the registered image without the retouch may be achieved by a storage mechanism other than the photograph storage unit 221. The retouch may be reversible. That is, deleting the retouch may be restoring the image that is once restored, to the unretouched image. In this case, the processing unit 211 may add the retouch that cannot be deleted by a mechanism other than the processing unit 211. The processing unit 211 may add the retouch by using techniques/technologies such as advanced encryption that prevent the mechanism other than the processing unit 211 from making the image viewable. Deleting the retouch may be an operation that is allowed to be performed only by the processing unit 211. That is, deleting the retouch may be an operation that is not allowed to be performed by the mechanism other than the processing unit 211. Since the user using the service provided by the information processing apparatus 2 cannot control the operation of the processing unit 211, it is hardly possible to delete the retouch, even when the retouch is reversible.

For example, when the user UA permits being viewed by the user UB, the user UB can view the photograph in which the retouch for the user UA is deleted. Furthermore, when the user UA views his/her own photograph, the user UA can view the photograph in which the retouch for his/her person area is deleted. On the other hand, when the determination unit 213 determines that the user UB is not permitted to view the user UA, the processing unit 211 adds the retouch for the person area.

For example, in a group photograph capturing a plurality of users, the retouch may be deleted from the person areas of users who permit being viewed, while the retouch may be added to the person areas of users who do not permit being viewed. The processing unit 211 may also add the retouch to persons who cannot be identified as users. FIG. 3 illustrates an example of a group photograph GP capturing a plurality of users. For example, as illustrated in FIG. 3(a), it is assumed that a group photograph GPhB in which the retouch is not added includes a user UA, a user UB, a user UC, a user UD, a user UE, and a user UF, as well as a person whose body is half visible. It is also assumed that the user UB is permitted to view the users UA, UC, UD, and UF, but is not permitted to view the user UE. In this case, when the user UB views the group photograph GPh, as illustrated in FIG. 3(b), a group photograph GPhA in which the retouch is added to the person area of the user UE, is provided. In addition, the identification unit 212 may not be allowed to identify the person with a half body cut, and the processing part 211 may add the retouch to the person with a half body cut.

With regard to the person who cannot be identified by the identification unit 212, the processing unit 211 may add the retouch for the person area of the person, regardless of which user views the photograph.

To the photographs stored in the photograph storage unit 221, information indicating the user identified by the identification unit 212 may be added. For each of the photographs stored in the photograph storage unit 221, the identification unit 212 identifies a person in the photograph and a person area thereof. The identification unit 212 may identify an individual by face verification. This improves searchability of the photograph capturing the person, which is stored in the photograph storage unit 221.

The operation of the processing unit 211 may be performed at any time.

[Case 1: Storing Photograph in which Retouch is Added]

In a case 1, the photograph storage unit 221 stores a photograph in which the retouch is added. When a new photograph is stored in the photograph storage unit 221, the processing unit 211 may add the retouch for a person area including a predetermined part of a person in the photograph.

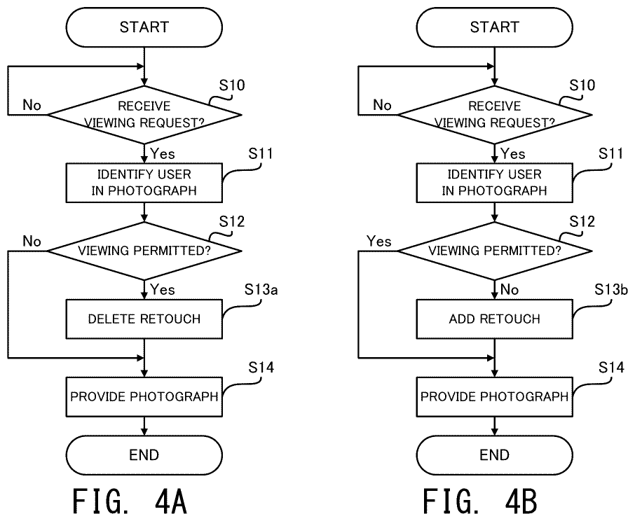

As illustrated in FIG. 4(a), when the user UB wishes to view the photograph (step S10: Yes), the identification unit 212 identifies the user UA captured in the photograph (step S11).

The processing unit 211 determines whether or not the user UA captured in the photograph permits the user UB to view the user UA (step S12). When the user UA permits the user UB to view the user UA (the step S12: Yes), the processing unit 211 deletes the retouch for the person area of the user UA captured in the photograph (step S13a). When the user UA does not permit the user UB to view the user UA (the step S12: No), the processing unit 211 does not delete the retouch for the person area of the user UA in the photograph, and proceeds to a step S14. In the step S14, the photograph provision unit 216 provides the photograph to the user UB.

[Case 2: Storing Photograph in which Retouch is not Added]

In a case 2, the photograph storage unit 221 stores a photograph in which the retouch is not added. In the case 2, as illustrated in FIG. 4(b), when the user UA permits the user UB to view the user UA, the processing unit 211 provides the user UB with the photograph in which the retouch is not added to the person area of the user UA. In addition, when the user UA does not permit the user UB to view the user UA (the step S12: No), the processing unit 211 adds the retouch for the person area of the user UA (step S13b). When the user UA permits the user UB to view the user UA (the step S12: Yes), the processing unit 211 does not add the retouch for the person area of the user UA in the photograph, and proceeds to the step S14.

In both the cases 1 and 2, when the user UA permits the user UB to view the user UA (the step S12: Yes), in the step S14, the photograph provision unit 216 provides the user UB with the photograph in which the retouch is not added to the person area of the user UA. In addition, in both the cases 1 and 2, when the user UA does not permit the user UB to view the user UA (the step S12: No), in the step S14, the photograph provision unit 216 provides the user UB with the photograph in which the retouch is added to the person area of the user UA.

### [2-3-4: Permission/Refusal Operation for Each User or Group]

The transmission/reception control unit 214 may receive, from the user UA serving as the identified person, viewability information indicating whether or not viewing is possible for each user UB serving as the viewer. The transmission/reception control unit 214 may provide a user interface for receiving the viewability information, on the display D of the terminal apparatus used by the user. The storage control unit 215 may store the received viewability information in the viewability information table 223. The viewability information may include permission information indicating viewing permission, and refusal information indicating viewing refusal. A viewing permission state between users may be managed in the viewability information table 223. In the viewability information table 223, the viewability information indicating whether or not the viewer is permitted to view the identified person, may be registered, as illustrated in the following Table 1.

TABLE 1
[Viewability Information Table 223]

| Identified Person | Viewer | Viewability |
|---|---|---|
| UA | UB | Permitted |
| UA | UC | Permitted |
| UA | UD | Permitted |
| UA | UE | Permitted |
| UA | UF | Permitted |
| UA | GX | Permitted |
| UA | GY | Refused |
| UB | UA | Permitted |
| UB | UC | Permitted |
| UB | UD | Permitted |
| UB | UD | Permitted |
| UB | UF | Permitted |

The above Table 1 illustrates that a user identified by “UB”, a user identified by “UC”, a user identified by “UD”, a user identified by “UE”, a user identified by “UF”, and a user included in a group identified by “GX” are permitted to view a user identified by “UA”. It also illustrates that viewing the user identified by “UA” is refused to a user included in a group identified by “GY”. It also illustrates that the user identified by “UA”, the user identified by “UC”, the user identified by “UD”, the user identified by “UE”, and the user identified by “UF” are permitted to view the user identified by “UB”.

That is, the transmission/reception control unit 214 may receive, from the user, the viewability information indicating whether or not viewing is possible for each individual user. The transmission/reception control unit 214 may also receive, from the user, the viewability information indicating whether or not viewing is possible for a plurality of users included in a group. The group may be a class, for example. The group may include participants in extracurricular activities.

The transmission/reception control unit 214 may receive the viewability information at any time. When the storage control unit 215 receives the viewability information, it registers it in the viewability information table 223. For example, the transmission/reception control unit 214 may receive the viewability information at a time of user registration.

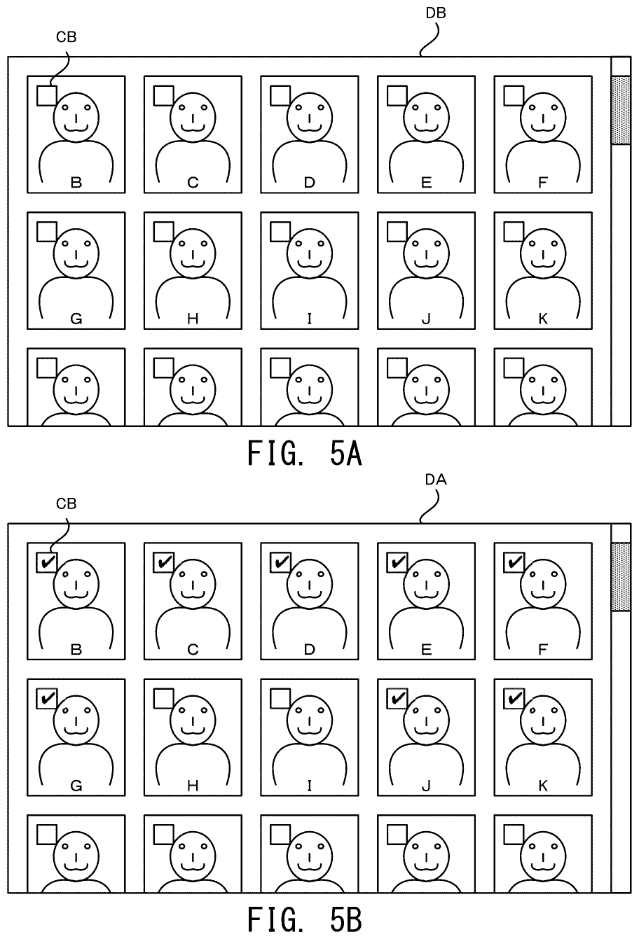

FIG. 5 illustrates an example of a user interface for receiving an input from the user UA to permit being viewed by other users. The user interface may be provided on the display D installed in the terminal apparatus used by the user UA. As illustrated in FIG. 5(a), a check box

CB may be displayed for each user in a display DB, together with the face image and the name serving as information indicating the user. The user UA may be able to check the check box CB of the user to whom viewing permission is given, to input the permission information. The user may be able to check the check box CB by selecting it by clicking, tapping, or similar actions. For example, when the user UA gives viewing permission to the users UB, UC, UD, UE, UF, UG, UJ, and UK, as illustrated in FIG. 5(b), the check boxes CK corresponding to the users UB, UC, UD, UE, UF, UG, UJ, and UK may be checked on a display DA.

For example, in a case where the viewer is a friend or the like to whom the identified person wishes to show photographs, the identified person may permit the viewer. The identified person may permit the viewer to view all the photographs in which the identified person is captured. Alternatively, the identified person may permit the viewer to view each photograph individually.

In addition, the transmission/reception control unit 214 may be configured to receive an input of the refusal information indicating refusal. In this case, the user does not wish to receive a viewing request from the refused user, the user may control the viewing request not to be submitted.

### [2-3-5: Permission/Refusal Operation for Each Photograph]

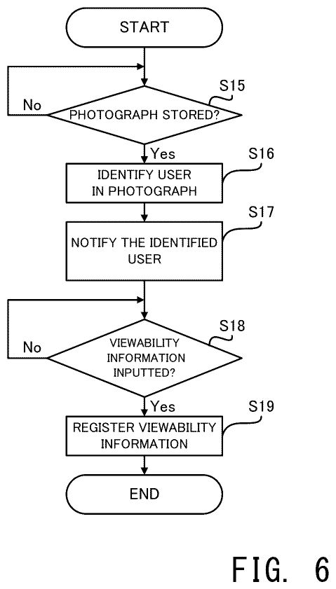

With reference to FIG. 6, a permission/refusal operation for each photograph will be described. FIG. 6 is a flowchart illustrating a flow of a permission/refusal operation for each photograph when a new photograph is stored. FIG. 6 illustrates an example of the flow of the permission/refusal operation for each photograph when a new photograph is stored, but the permission/refusal operation for each photograph may be carried out at any time.

As illustrated in FIG. 6, when a new photograph is stored in the photograph storage unit 221 (step S15: Yes), the identification unit 212 identifies the user in the photograph (step S16). The transmission/reception control unit 214 notifies the identified user that the user is included in the newly stored photograph (step S17). When the identification unit 212 identifies a plurality of users in the photograph, the transmission/reception control unit 214 may notify the plurality of users that the users are included in the newly stored photograph. The photograph stored in the photograph storage unit 221 may be associated with information indicating the users in the photograph.

The user may input the viewability information indicating at least one of whether or not viewing of the newly stored photograph is possible, and whether or not viewing is possible for each user who views the photograph. In a case where the user does not mind the photograph being made public, the user may input the permission information indicating permission to view the photograph. When the user does not wish the photograph to be made public, the user may input the refusal information indicating refusal to view the photograph. The transmission/reception control unit 214 determines whether or not an input of the viewability information on the photograph is received from the user (step S18).

When the input of the viewability information is received (the step S18: Yes), the storage control unit 215 registers the viewability information in the viewability information table 223 (step S19).

In addition, the user may be able to check/confirm information about the user himself/herself, among pieces of information managed in the photograph storage unit 221 and the viewability information table 223. The user may be able to check/confirm all the photographs capturing the user himself/herself, which are stored in the photograph storage unit 221, at any time. The user may be able to check/confirm a viewability state registered in the viewability information table 223. The transmission/reception control unit 214 may receive from the user, at any time, at least one of the viewability information indicating whether or not viewing of each photograph is possible, and the viewability information indicating whether or not viewing is possible for each user who views the image. In this case, the storage control unit 215 may further store each photograph in the viewability information table 223, in association with the viewability information.

The viewability information table 223 may further store therein, each identified person captured in the photograph, in association with the viewer to whom viewing permission is given. For example, as illustrated in the following Table 2, the viewability information indicating whether or not the viewer is permitted to view the identified person, may be further registered in the viewability information table 223, for each photograph and for each identified person captured in the photograph.

TABLE 2
[Viewability Information Table 223]

| | Identified | | |
|---|---|---|---|
| Photograph | Person | Viewability | Viewer |
| Ph1 | UA | Permitted | All users permitted |
| Ph1 | UB | Permitted | All users permitted |
| Ph1 | UC | Permitted | All users permitted |
| Ph1 | UD | Permitted | All users permitted |
| Ph2 | UA | Refused | All users |
| Ph3 | UA | Refused | All users |
| Ph3 | UB | Permitted | All users permitted |
| Ph4 | UA | Refused | UC and UD out of all |
| | | | users permitted |
| Ph4 | UE | Permitted | All users permitted |
| Ph4 | UF | Permitted | All users permitted |

The above Table 2 illustrates that all the users permitted by the user UA identified by “UA” captured in a photograph Ph1, are permitted to view the user UA. All the users permitted by the user UA may be the user identified by “UB”, the user identified by “UC”, the user identified by “UD”, the user identified by “UE”, the user identified by “UF”, and the user included in the group identified by “GX”, as illustrated in the above Table 1. In addition, the Table 2 also illustrates that all the users permitted by the user UB identified by “UB” captured in the photograph Ph1 are permitted to view the user UB. In addition, it also illustrates that all the users permitted by the user UC identified by “UC” captured in the photograph Ph1 are permitted to view the user UC. It also illustrates that all the users permitted by the user UD identified by “UD” in the photograph Ph 1 are permitted to view the user UD.

It also illustrates that viewing the user UA identified by “UA” in a photograph Ph 2 is refused to all the users. Since only the user UA is captured in the photograph Ph2, the information processing apparatus 2 may prevent the photograph Ph2 itself from being viewed by anyone. In a case where the user captured in the photograph is only the user who refuses to be viewed, the information processing apparatus 2 may delete the photograph itself from the photograph storage unit 221. That is, the transmission/reception control unit 214 may receive/accept a request to delete the photograph that the user does not wish to make public.

In addition, the Table 2 illustrates that viewing the user UA identified by “UA” in a photograph Ph 3 is refused to all the users. In addition, it also illustrates that all the users permitted by the user UB identified by “UB” in the photograph Ph3 are permitted to view the user UB. In this case, the processing unit 211 may add the retouch to the person area of the user UA. As the addition of the retouch, the processing unit 211 may replace the person area of the user UA with a background image, or the like. That is, the processing unit 211 may edit the photograph Ph2 such that the user UA is not visible in the photograph.

If the user UB also refuses to be viewed in the photographs of all the users, the information processing apparatus 2 may prevent the photograph Ph3 itself from being viewed by anyone. That is, in a case where all the users captured in the photograph refuse to be viewed, the information processing apparatus 2 may delete the photograph itself from the photograph storage unit 221.

In addition, the Table 2 illustrates that viewing the user UA identified by “UA” in a photograph Ph 4 is refused to the user UC identified by “UC” and the user UD identified by “UD”, out of the users permitted by the user UA. In addition, it illustrates that all the users permitted by the user UE identified by “UE” in the photograph Ph4 are permitted to view the user UE. It also illustrates that all the users permitted by the user UF identified by “UF” in the photograph Ph 4 are permitted to view the user UF. In this case, when the user UC or the user UD views the photograph Ph 4, the processing unit 211 may add the retouch to the person area of the user UA. The processing unit 211 adds the retouch to the person area of the person, or deletes the added retouch, depending on the viewing permission state managed in the viewability information table 223.

### [2-3-6: Flow of Use]

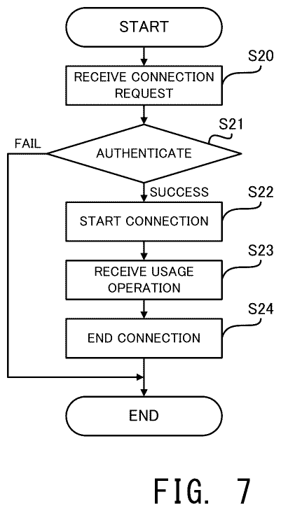

With reference to FIG. 7, a flow of use of the service provided by the information processing apparatus 2 will be described. FIG. 7 is a flowchart illustrating the flow of the use of the information processing apparatus 2.

As illustrated in FIG. 7, the information processing apparatus 2 receives/accepts, from the user, a request to connect to the service provided by the information processing apparatus 2 (step S20). The transmission/reception control unit 214 may display a login screen on the display D of the terminal apparatus used by the user.

The identification unit 212 authenticates the user (step S21). The identification unit 212 may acquire the face image of the user, may authenticate the user by using the face image, and may determine whether or not the user is allowed to log in.

When the user is successfully authenticated (the step S21: success), the information processing apparatus 2 starts the user's connection to the service provided by the information processing apparatus 2 (step S22). The user can log in to the service provided by the information processing apparatus 2.

The information processing apparatus 2 receives a usage operation by the user (step S23). The user may perform the usage operation of using the service provided by the information processing apparatus 2, by connecting to the information processing apparatus 2 from the terminal apparatus that is usable by the user and operating the terminal apparatus, in the same way as the registration operation. The information processing apparatus 2 may authorize the usage operation of the user, by the face authentication, even after login. The usage operation may include a viewing operation, an operation of inputting viewing request information, an operation of inputting the viewability information indicating whether or not viewing is possible, and the like.

When the user finishes the usage operation and wishes to log out, the information processing apparatus 2 ends the user's connection to the service provided by the information processing apparatus 2 (step S24). Alternatively, in a case where the face authentication is not successful for a predetermined time or more, for example, in a case where the user leaves from a camera configured to acquire the face image for a predetermined time or more, the user may be logged out.

Login permission may not be based on the face authentication. For example, it may be based on ID password authentication using an ID and a password. In this case, it is not necessary to register the face image. In this case, the user who does not register the face image may be a user who cannot be viewed by other users. That is, the person area of the user may always be retouched, and the user may be treated in the same way as a person who is not registered.

The administrator may be able to check/confirm the information managed in the photograph storage unit 221 and the information managed in the viewability information table 223. For example, in order to allow the user to enjoy using the service provided by the information processing apparatus 2, the information processing apparatus 2 may recommend a person to whom viewing permission is given, to the user. In addition, it may be provided as terms of use that the administrator acquires information on the viewing permission state of each user. Furthermore, the administrator may encourage the user to submit the viewing request, based on this information. In addition, the administrator may acquire information on social relationships and may use it to prevent bullying.

### [2-4: Technical Effect of Information Processing Apparatus 2]

When sharing a photograph, in some cases, permission by a person himself captured in the photograph is uncertain, or there is a possibility of privacy invasion. Users, and a school or the like that manages and operates photographs, are concerned about privacy invasion, and sometimes, it is hardly possible to share photographs of precious memories.

The information processing apparatus 2 in the second example embodiment is allowed to provide a photograph sharing system that respects privacy, wherein viewing is possible only for a person to whom viewing permission is given. As the user can share his/her photographs only with the viewer permitted by the user himself, the user can use the service with peace of mind. By applying this to a service for sharing photographs in a community such as a school, it is possible to provide a function of managing viewing permissions while respecting privacy.

### 3: Third Example Embodiment

Next, an information processing apparatus, an information processing method, and a recording medium according to a third example embodiment will be described. The following describes the information processing apparatus, the information processing method, and the recording medium according to the third example embodiment, by using an information processing apparatus 3 to which the information processing apparatus, the information processing method, and the recording medium according to the third example embodiment are applied.

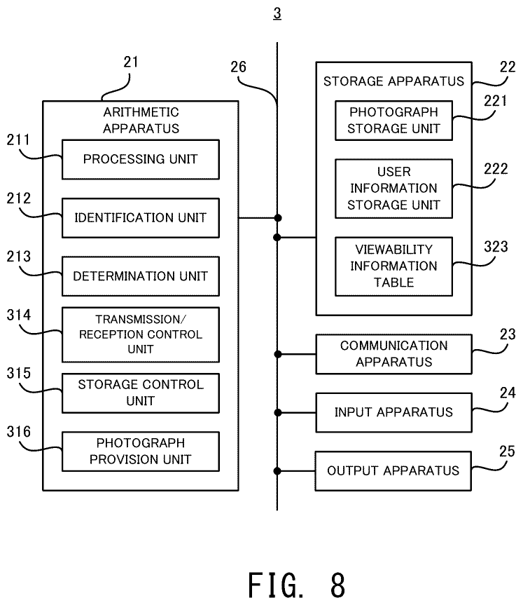

FIG. 8 is a block diagram illustrating a configuration of the information processing apparatus 3 in the third example embodiment. The information processing apparatus 3 in the third example embodiment differs from the information processing apparatus 2 in the second example embodiment, in the operation of a transmission/reception control unit 314, a storage control unit 315, and a photograph provision apparatus 316. The transmission/reception control unit 314 in the third example embodiment may be a specific example of the “viewability information receiving unit,” the “request information receiving unit,” and “request transmitting unit” described later in Supplementary Notes.

### 3-1: Information Processing Operation Performed by Information Processing Apparatus 3

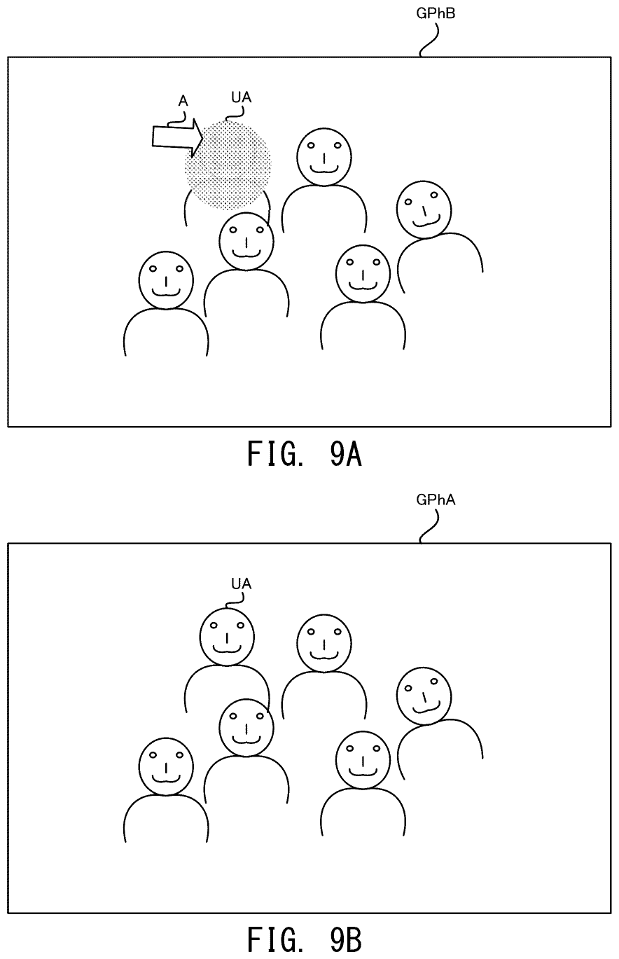

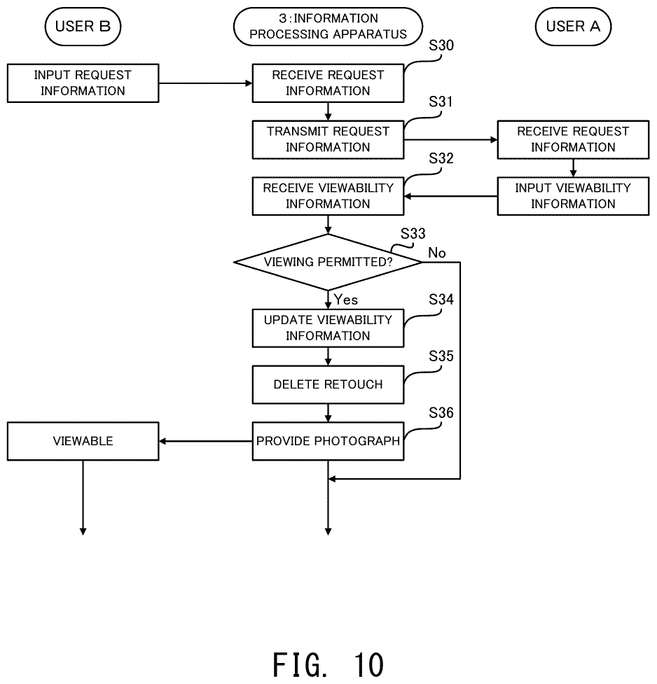

With reference to FIG. 9 and FIG. 10, an information processing operation performed by the information processing apparatus 3 will be described. FIG. 9 illustrates an example of a user interface provided by the information processing apparatus 3. FIG. 10 is a flowchart illustrating a flow of the information processing operation performed by the information processing apparatus 3.

FIG. 9 illustrates a group photograph GPh that can be viewed by the user UB. FIG. 9(a) illustrates a state in which the user UB is not permitted to view the user UA. As illustrated in FIG. 9(a), blurring may be added to the person area of the user UA.

As illustrated in FIG. 10, when the user UB is not permitted to view the user UA and wishes to view the user UA, the user UB inputs request information indicating the wish. It may be rephrased as the user UB applying for permission to share a photograph with the user UA with whom the photograph is not yet shared. The user UB may be able to submit the viewing request to a person who is not identifiable due to the retouch being added to the photograph.

The user UB may input the request information to the terminal apparatus of the user UB. The transmission/reception control unit 314 may provide a user interface capable of receiving an input on the display D of the terminal apparatus of the user UB. The transmission/reception control unit 314 receives an input of the request information (step S30). The transmission/reception control unit 314 receives the inputted request information. The request information may be information indicating a request for viewing permission.

As illustrated in FIG. 9(a), the user UB may be able to specify/designate the person area of the user UA to which the retouch is added, as indicated by an arrow A. By specifying/designating the person area of the user UA to which the retouch is added, the user UB may be able to input the request information indicating a wish to view the user UA. Specifying/designating the person area of the user UA to which the retouch is added, may be an operation of clicking on the person area by using a mouse, or an operation of tapping on the person area on a touch panel.

As illustrated in FIG. 10, the transmission/reception control unit 314 transmits the request information to the user UA (step S31). The transmission/reception control unit 314 may allow a message to be displayed on the terminal apparatus used by the user UA. The transmission/reception control unit 314 may transmit a message indicating that a request for permission is submitted, to the contact details of the user UA registered, with reference to the user information storage unit 222.

The user UA receives the request information and inputs the viewability information. When the user UA permits being viewed by the user UB, the user UA inputs the permission information. When the user UA does not permit being viewed by the user UB, the user UA inputs the refusal information. The transmission/reception control unit 314 may provide a user interface capable of receiving an input on the display D of the terminal apparatus of the user UA. The transmission/reception control unit 314 receives the viewability information (step S32).

The photograph provision unit 316 determines whether or not the permission information indicating that the user UB is permitted to view the user UA, is acquired from the user UA (step S33). When the photograph provision unit 316 acquires from the user UA the permission information indicating that the user UB is permitted to view the user UA (the step S33: Yes), the storage control unit 315 updates the permission information registered in the viewability information table 323 (step S34). The processing unit 211 deletes the retouch for the person area of the user UA (step S35). Due to an operation of deleting the retouch by the processing unit 211, a group photograph GPhB illustrated in FIG. 9(a) may be changed to a group photograph GPhA illustrated in FIG. 9(b).

The photograph provision unit 316 provides the user UB with the photograph in which the retouch for the person area of the user UA is deleted (step S36). The user UB can view the photograph in which the user UA without the retouch is visible.

In addition, even in the third example embodiment, the transmission/reception control unit 314 may also receive/accept the request for permission from a group including a plurality of users. The transmission/reception control unit 314 may also receive/accept the viewability information about the groups including a plurality of users.

### 3-2: Modification

The transmission/reception control unit 314 may also receive the request information indicating a viewing wish for each photograph. In this case, the transmission/reception control unit 314 may transmit the request information to all the users captured in the photograph for which viewing is desired. The processing unit 211 may delete the retouch for the person areas of a user who gives viewing permission. For example, in a case where all the users captured in the photograph give viewing permission, the processing unit 211 may delete the retouch for the person areas of all the users captured in the photograph.

For example, in a case where the user UX desires the photograph Ph1 capturing the users UA, UB, UC, and UD, and in a case where the users UA, UB, UC, and UD permit the user UX to view the photograph Ph1, the storage control unit 315 may update the viewability information table 323 illustrated in the above Table 2, as illustrated in the following Table 3.

TABLE 3
[Viewability Information Table 323]

| | Identified | | |
|---|---|---|---|
| Photograph | Person | Viewability | Viewer |
| Ph1 | UA | Permitted | All users |
| | | | permitted + UX |
| Ph1 | UB | Permitted | All users |
| | | | permitted + UX |
| Ph1 | UC | Permitted | All users |
| | | | permitted + UX |
| Ph1 | UD | Permitted | All users |
| | | | permitted + UX |
| Ph2 | UA | Refused | All users |
| Ph3 | UA | Refused | All users |
| Ph3 | UB | Permitted | All users permitted |
| Ph4 | UA | Refused | UC and UD out of all |
| | | | users permitted |
| Ph4 | UE | Permitted | All users permitted |
| Ph4 | UF | Permitted | All users permitted |

The above Table 3 illustrates that the user UX is added to the viewer column for the users UA, UB, UC, and UD captured in the photograph Ph1. The user UX may be able to view only the photograph Ph1, out of the photographs capturing the users UA, UB, UC, and UD.

### 3-3: Technical Effect of Information Processing Apparatus 3

When the viewer recognizes a part to which the retouch is added during photograph viewing, the information processing apparatus 3 in the third example embodiment is allowed to receive/accept the request for viewing permission for the identified person captured in that part, and when viewing is permitted, the information processing apparatus 3 is allowed to provide the viewer with the photograph in which the retouch is not added.

### 4: Fourth Example Embodiment

Next, an information processing apparatus, an information processing method, and a recording medium according to a fourth example embodiment will be described. The following describes the information processing apparatus, the information processing method, and the recording medium according to the fourth example embodiment, by using an information processing apparatus 4 to which the information processing apparatus, the information processing method, and the recording medium according to the fourth example embodiment are applied.

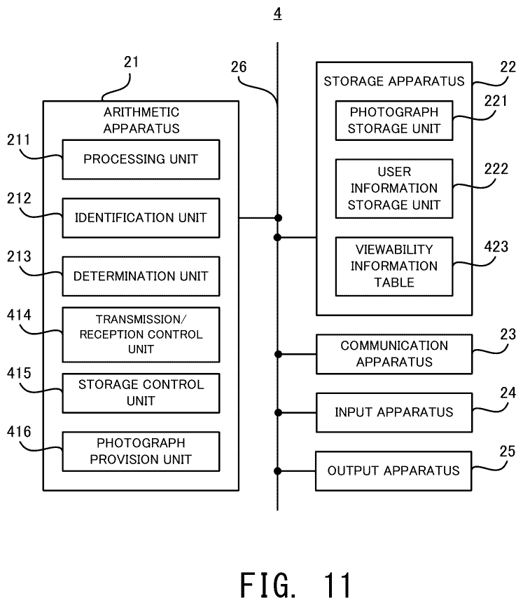

FIG. 11 is a block diagram illustrating a configuration of the information processing apparatus 4 in the fourth example embodiment. The information processing apparatus 4 in the fourth example embodiment differs from the information processing apparatus 2 in the second example embodiment and the information processing apparatus 3 in the third example embodiment, in the operation of a transmission/reception control unit 414, a storage control unit 415, and a photograph provision apparatus 416.

### [4-1: Information Processing Operation Performed by Information Processing Apparatus 4]

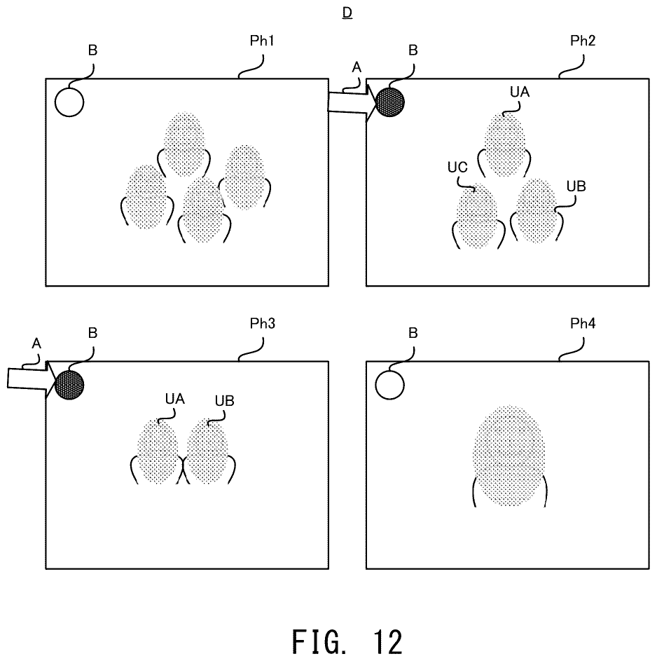

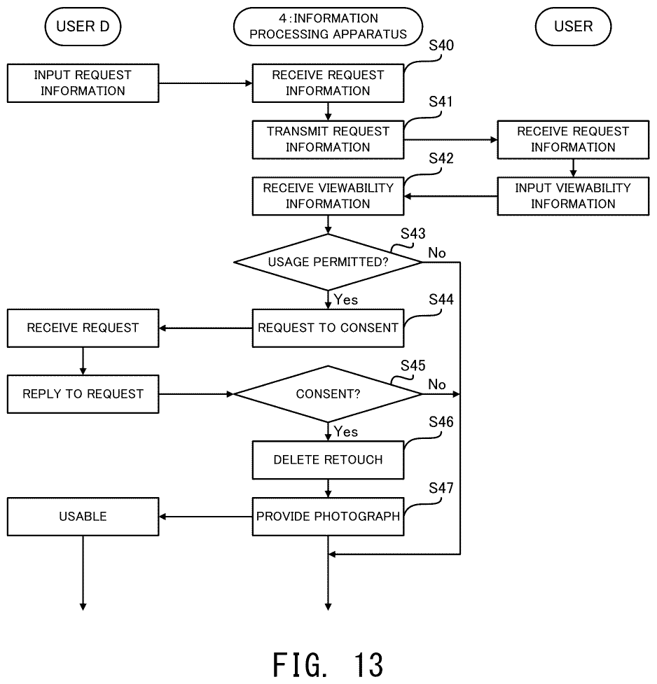

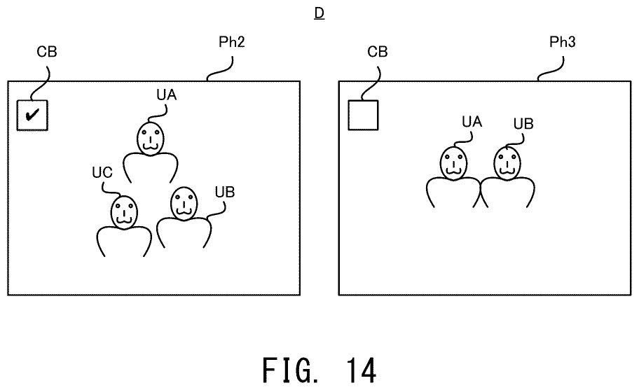

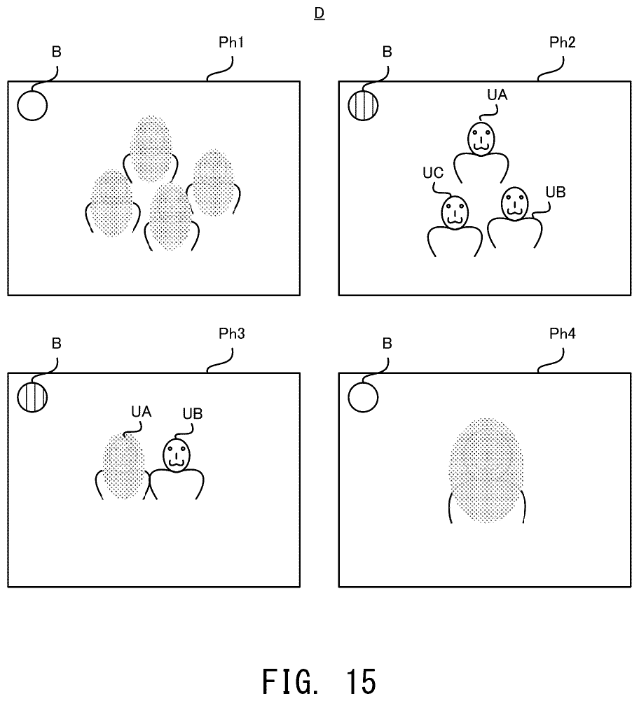

With reference to FIG. 12 to FIG. 15, an information processing operation performed by the information processing apparatus 4 will be described. FIG. 12, FIG. 14, and FIG. 15 illustrate examples of a user interface provided by the information processing apparatus 4. FIG. 13 is a flowchart illustrating a flow of the information processing operation performed by the information processing apparatus 4.

FIG. 12 illustrates a display example of the display D of the terminal apparatus used by the user UD. FIG. 12 illustrates that photographs Ph1, Ph2, Ph3, and Ph4 are displayed on the display D of the terminal apparatus used by the user UD. As illustrated in FIG. 12, the retouch is added to the person areas of all the users captured in the photographs Ph1, Ph2, Ph3, and Ph4 displayed on the display D.

The user UD may not only wish to connect to a service provided by the information processing apparatus 4 to view photographs, but may also wish to use the photographs outside the information processing apparatus 4. Using the photographs outside the information processing apparatus 4 may include, for example, publishing photographs in paper media, such as publications. The user UD may be, for example, a public relations committee member. The user UD may wish to use the photographs Ph2 and Ph3 outside the information processing apparatus 4, for example.

As illustrated in FIG. 13, when the user UD wishes to use the photograph, the user UD inputs the request information indicating the wish. The user UD may be able to submit a request for use to a user who is not identifiable due to the retouch being added to the photograph.

The user UD may input the request information to the terminal apparatus of the user UD. The transmission/reception control unit 414 may provide a user interface capable of receiving an input on the display D of the terminal apparatus of the user UD. The transmission/reception control unit 414 receives an input of the request information indicating a wish to view a specified image including the identified person (step S40). The transmission/reception control unit 414 receives the inputted request information. The request information may be information indicating a request for usage permission.

As illustrated in FIG. 12, the transmission/reception control unit 414 may add, to each photograph, a button B that is selectable by the user. The user UD who wishes to use the photographs Ph2 and Ph3 may be able to specify/designate the button B of the photograph Ph2 and the button B of the photograph Ph3, as illustrated by arrows A. When receiving the designation, the transmission/reception control unit 414 may change aspects of the button B of the photograph Ph2 and the button B of the photograph Ph3. For example, when receiving the designation, the transmission/reception control unit 414 may change colors of the button B of the photograph Ph2 and the button B of the photograph Ph3. Specifying/designating the button B added to the photograph may be an operation of clicking on the person area by using a mouse, or an operation of tapping on the person area on a touch panel.

As illustrated in FIG. 13, the transmission/reception control unit 414 transmits the request information to the user captured in the photograph (step S41). The transmission/reception control unit 414 may transmit the request information to all the users captured in the photograph. The transmission/reception control unit 414 may allow a message to be displayed on the terminal apparatus used by the user. The transmission/reception control unit 414 may transmit a message indicating that the request for usage permission is submitted, to the contact details of the user registered, with reference to the user information storage unit 222. That is, the user UD may be able to submit the request for use to the user captured in the photograph, without knowing who the user captured in the photograph is, or without knowing the contact details of the user.

The user receives the request information and inputs the viewability information. When the user gives permission to use the photograph of the user UD, the user inputs the permission information. When the user does not give permission to use the photograph of the user UD, the user inputs the refusal information. The transmission/reception control unit 414 may provide a user interface capable of receiving an input on the display D of the terminal apparatus used by the user.

FIG. 14 illustrates display examples of the display D of the terminal apparatus used by the user UA. Since the user UA is captured in both the photograph Ph2 and the photograph Ph3 that the user UD wishes to use, the transmission/reception control unit 414 may transmit the request information about both the photograph Ph2 and the photograph Ph3, to the terminal apparatus used by the user UA. In a case where viewing permission is given to the user UA from the user UB and the user UC, as illustrated in FIG. 14, the photograph provision unit 416 may provide the photographs Ph2 and Ph3 without the retouch.

As illustrated in FIG. 14, the transmission/reception control unit 414 may add, to each photograph, the check box CB that is selectable by the user. For example, in a case where the user UA permits the user UD to use the photograph Ph2, but does not permit the user UD to use the photograph Ph3, only the check box CB of the photograph Ph2 may be checked. That is, the user captured in the photograph may be able to make a response of permission or refusal regarding the use of the photograph by the user UD, even without knowing the contact details of the user UD.

The transmission/reception control unit 414 receives the viewability information (step S42). The transmission/reception control unit 414 may receive the viewability information from all the users captured in the photograph.

The transmission/reception control unit 414 determines whether or not the permission information indicating that the user UD is permitted to use the photograph, is acquired from each user (step S43). When the transmission/reception control unit 414 determines that the permission information indicating that the user UD is permitted to use the photograph, is acquired from the user (the step S43: Yes), the transmission/reception control unit 414 requests the user UD to consent to a usage agreement (step S44). The transmission/reception control unit 414 may transmit a request for consent to the terminal apparatus used by the user UD. The user UD receives the request for consent and responds to the request.

The transmission/reception control unit 414 receives the response from the user UD and determines whether or not the user UD has consented (step S45). When the user UD has consented, the processing unit 211 deletes the retouch for the person area of the user who has consented to the usage (step S46).

The photograph provision unit 416 provides the user UD with the photograph in which the retouch is deleted from the person area of the user who gives usage permission (step S47). FIG. 15 illustrates examples of photographs provided to the user UD by the photograph provision unit 416 in a case where the user UA permits only the use of the photograph Ph2, the user UB permits the use of both the photographs Ph2 and Ph3, and the user UC permits the use of the photograph Ph2. Furthermore, as illustrated in FIG. 15, the transmission/reception control unit 414 may change an aspect of the button B of the photograph for which the viewability information is already acquired from the user captured in the photograph that the viewer wishes to use. The user UD may use the photograph in which the retouch is not added for the user who gives usage permission.

### [4-2: Technical Effect of Information Processing Apparatus 4]

There are cases where a school, a PTA, or the like, wishes to use photographs in publicity materials or the like, to report to various people such as local residents, on activities or the like. However, it is sometimes not easy to get in touch with the individuals captured in the photographs. First of all, it is not easy to identify who the individuals captured in the photographs are. It is also not easy to obtain the contact details of the identified individuals. Furthermore, it is not easy for the individuals contacted to accept contact from a stranger.

The information processing apparatus 4 in the fourth example embodiment is configured to obtain permission from a person himself in advance so as to avoid the person's unintentional use. Even in the case of use outside the information processing apparatus 4, it is possible to obtain the permission from the person himself in advance. In addition, the information processing apparatus 4 is allowed to provide a mechanism in which the user UD can submit the request for use to the user captured in the photograph, without knowing who the user captured in the photograph is, and without knowing the contact details of the user, and in which the user captured in the photograph can make a response of permission or refusal regarding the use of the photograph by the user UD, even without knowing the contact details of the user UD. The information processing apparatus 4 is allowed to provide a mechanism that enables communication even when the contact details are not known.

### 5: Fifth Example Embodiment

Next, an information processing apparatus, an information processing method, and a recording medium according to a fifth example embodiment will be described. The following describes the information processing apparatus, the information processing method, and the recording medium according to the fifth example embodiment, by using an information processing apparatus 5 to which the information processing apparatus, the information processing method, and the recording medium according to the fifth example embodiment are applied.

### [5-1: Configuration of Information Processing Apparatus 5]

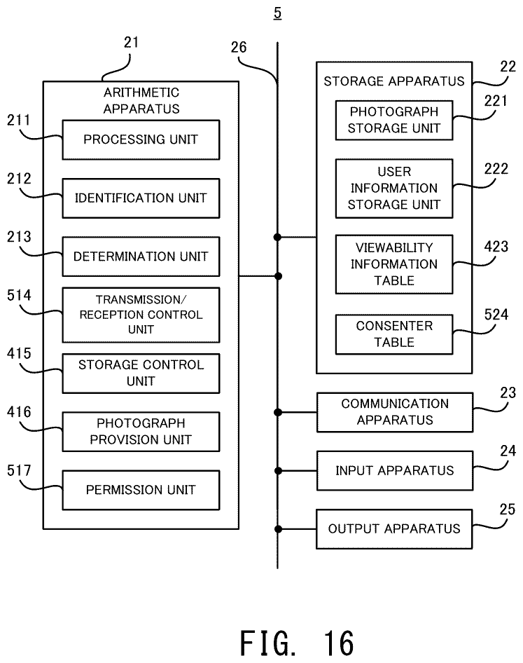

As illustrated in FIG. 16, the information processing apparatus 5 in the fifth example embodiment includes the arithmetic apparatus 21 and the storage apparatus 22, as in the information processing apparatus 2 in the second example embodiment to the information processing apparatus 4 in the fourth example embodiment. Furthermore, the information processing apparatus 5 in the fifth example embodiment may include the communication apparatus 23, the input apparatus 24, and the output apparatus 25, as in the information processing apparatus 2 in the second example embodiment to the information processing apparatus 4 in the fourth example embodiment. The information processing apparatus 5, however, may not include at least one of the communication apparatus 23, the input apparatus 24, and the output apparatus 25. The information processing apparatus 5 in the fifth example embodiment differs from the information processing apparatus 2 in the second example embodiment to the information processing apparatus 4 in the fourth example embodiment, in that the arithmetic apparatus 21 further realizes a permission unit 517 and the storage apparatus 22 further includes a consenter table 524. In addition, a transmission/reception control unit 514 in the fifth example embodiment may be a specific example of the “viewability information receiving unit”, the “request information receiving unit”, “desired transmission means”, and the “consent transmitting unit” described later in Supplementary Notes. Other features of the information processing apparatus may be the same as those of at least one of the information processing apparatus 2 in the second example embodiment to the information processing apparatus 4 in the fourth example embodiment. For this reason, a part differing from each of the example embodiments described above will be described in detail below, and a description of the other overlapping parts will be omitted as appropriate.

### [Consenter Table 524]

In the consenter table 524, a user and a consenter who consents to inputted content received from the user, are registered in association with each other. The user may include the identified person and the viewer. The user may be the user UC. The user UC may be a person for whom it is preferable to obtain consent from a guardian, regarding his/her own words and actions. The user UC may be, for example, an elementary school student. The consenter may be a guardian P of the user UC. The guardian P may be the user. That is, the guardian P may be able to log in to a service provided by the information processing apparatus 5.

### [5-2: Information Processing Operation Performed by Information Processing Apparatus 5]

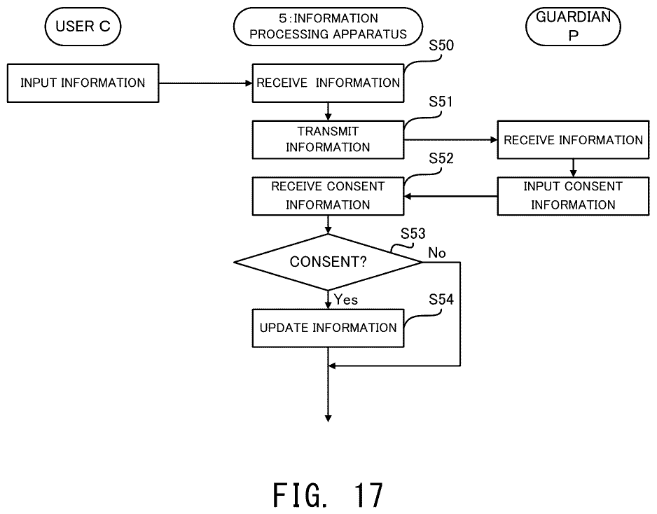

With reference to FIG. 17, an information processing operation of the information processing apparatus 5 will be described. FIG. 17 is a flowchart illustrating a flow of the information processing operation performed by the information processing apparatus 5.

As illustrated in FIG. 17, the user UC inputs information. When the user UC is the identified person, the information may be the viewability information. When the user UC is the viewer, the information may be the request information. The transmission/reception control unit 514 receives an input of the information (step S50).

The transmission/reception control unit 514 transmits the information to the guardian P (step S51). The transmission/reception control unit 514 may display a message on the terminal apparatus used by the guardian P. When the guardian P is also the user, the transmission/reception control unit 514 may transmit a message indicating the information received from the user UC, to the contact details of the guardian P registered, with reference to the user information storage unit 222. When the guardian P is not the user, the transmission/reception control unit 514 may transmit a message indicating the information received from the user UC, to the contact details of the guardian P registered, with reference to the consenter table 524.

The guardian P receives the information and inputs consent information. In a case where the guardian P consents to the inputted content received from the user UC, the guardian P inputs the permission information. In a case where the guardian P does not consent to the inputted content received from the user UC, the guardian P inputs the refusal information. The transmission/reception control unit 514 may provide a user interface capable of receiving an input on the display D of the terminal apparatus of the guardian P. The transmission/reception control unit 514 receives the consent information (step S52).

The permission unit 517 determines whether or not the permission information indicating the consent to the inputted content received from the user, is acquired from the guardian P (step S53). When the permission unit 517 determines that the permission information indicating the consent to the inputted content received from the user UC, is acquired from the guardian P (the step S53: Yes), the permission unit 517 enables the inputted content received from the user UC (step S54). For example, in a case where the viewability information is received from the identified person, the permission unit 517 may permit updating of the viewability information table 423. Furthermore, in a case where the request information is received from the viewer, the permission unit 517 may permit transmission of the request information to the identified person.

The information processing apparatus 5 in the fifth example embodiment may be configured to switch from a user UC mode in which log in is performed by the user UC, to a guardian P mode in which the guardian P can perform the usage operation. In this case, the transmission/reception control unit 514 may receive an input from the user UC in the user UC mode, and may receive an input of the consent information from the guardian P in the guardian P mode. In a case where the consent is received from the guardian P, the permission unit 517 may enable the inputted content from the user UC, in the information processing apparatus 2.

### [5-3: Technical Effect of Information Processing Apparatus 5]

The information processing apparatus 5 in the fifth example embodiment enables the inputted content in response to the consent of the consenter. Therefore, in a case where the inputted contents are inappropriate, such inputted contents are not reflected.

### 6: Supplementary Notes

With respect to the example embodiments described above, the following Supplementary Notes are further disclosed.

### [Supplementary Note 1]

An information processing apparatus including:
a processing unit that adds or deletes a retouch for a person area including a predetermined part of a person in an image;
an identification unit that identifies a person corresponding to the person area, by using the person area; and
a determination unit that determines whether or not a viewer who views the image is permitted to view the identified person identified by the identification unit, wherein
the processing unit deletes the retouch for the person area, in response to a determination by the determination unit that the viewer is permitted to view the identified person, and
the processing unit adds the retouch for the person area, in response to a determination by the determination unit that the viewer is not permitted to view the identified person.

### [Supplementary Note 2]

The information processing apparatus according to Supplementary Note 1, further including:
a viewability information receiving unit that receives, from the identified person, viewability information indicating at least one of whether or not viewing is possible for each image, and whether or not viewing is possible for each viewer who views the image; and
a storage unit that stores therein the viewability information.

### [Supplementary Note 3]

The information processing apparatus according to Supplementary Note 1 or 2, further including:
a request information receiving unit that receives an input of request information indicating a wish, in response to the viewer being not permitted to view the identified person and wishing to view the identified person; and
a request transmitting unit that transmits the request information to the identified person, wherein
the processing unit deletes the retouch for the person area, in response to acquisition from the identified person of permission information indicating that the viewer is permitted to view the identified person.

### [Supplementary Note 4]

The information processing apparatus according to Supplementary Note 3, wherein
the request information receiving unit receives an input of the request information indicating a wish to view a specified image including the identified person, and
the processing unit deletes the retouch for the person area in the specified image, in response to acquisition from the identified person of permission information indicating that the viewer is permitted to view the specified image.

### [Supplementary Note 5]

The information processing apparatus according to any one of Supplementary Notes 1 to 4, further including:
a registration unit that registers the identified person and a consenter who consents to inputted content received from the identified person, in association with each other, and that registers the viewer and a consenter who consents to inputted content received from the viewer, in association with each other;
a consent transmitting unit that transmits the inputted content to a corresponding one the consenters, in response to reception of an input from the identified person or the viewer; and
a permission unit that enables the inputted content received from the identified person or the viewer, in response to reception of consent by the consenter.

### [Supplementary Note 6]

An information processing method including:
adding or deleting a retouch for a person area including a predetermined part of a person in an image;
identifying a person corresponding to the person area, by using the person area;
determining whether or not a viewer who views the image is permitted to view the identified person identified by using the person area;
deleting the retouch for the person area, in response to a determination that the viewer is permitted to view the identified person; and
adding the retouch for the person area, in response to a determination that the viewer is not permitted to view the identified person.

### [Supplementary Note 7]

A recording medium on which a computer program that allows a computer to execute an information processing method is recorded, the information processing method including:
adding or deleting a retouch for a person area including a predetermined part of a person in an image;
identifying a person corresponding to the person area, by using the person area;
determining whether or not a viewer who views the image is permitted to view the identified person identified by using the person area;
deleting the retouch for the person area, in response to a determination that the viewer is permitted to view the identified person; and
adding the retouch for the person area, in response to a determination that the viewer is not permitted to view the identified person.

### [Supplementary Note 8]

The information processing apparatus according to any one of Supplementary Notes 1 to 5, wherein
the processing units adds the retouch for the person area including the predetermined part of the person in the image, and
the processing units deletes the retouch for the person area, in response to acquisition from the identified person of permission information indicating that the viewer is permitted to view the identified person.

### [Supplementary Note 9]

The information processing apparatus according to any one of Supplementary Notes 1 to 5, wherein
the processing units adds the retouch for the person area, in response to acquisition from the identified person of non-permission information indicating that the viewer is not permitted to view the identified person.

This disclosure is allowed to be changed, if desired, without departing from the essence or spirit of this disclosure which can be read from the claims and the entire identification. An information processing apparatus, an information processing method, and a recording medium with such changes are also intended to be within the technical scope of this disclosure.

### DESCRIPTION OF REFERENCE CODES

1, 2, 3, 4, 5 Information processing apparatus
11, 211 Processing unit
12, 212 Identification unit
13, 213 Determination unit
214, 314, 414, 514 Transmission/reception control unit
215, 315, 415 Storage control unit
216, 316, 416 Photograph provision unit
517 Permission unit
221 Photograph storage unit
222 User information storage unit
223, 323, 423 Viewability information table
524 Consenter table

What is claimed is:

1. An information processing apparatus comprising:
at least one memory that is configured to store instructions; and
at least one processor that is configured to execute the instructions to:
add or delete a retouch for a person area including a predetermined part of a person in an image;
identify a person corresponding to the person area, by using the person area; and
determine whether or not a viewer who views the image is permitted to view the identified person;
delete the retouch for the person area, in response to a determination that the viewer is permitted to view the identified person; and
add the retouch for the person area, in response to a determination that the viewer is not permitted to view the identified person.

2. The information processing apparatus according to claim 1, wherein the at least one processor is configured to execute the instructions to:
receive, from the identified person, viewability information indicating at least one of whether or not viewing is possible for each image, and whether or not viewing is possible for each viewer who views the image; and
store therein the viewability information.

3. The information processing apparatus according to claim 1, wherein the at least one processor is configured to execute the instructions to:
receive an input of request information indicating a wish, in response to the viewer being not permitted to view the identified person and wishing to view the identified person;
transmit the request information to the identified person; and
delete the retouch for the person area, in response to acquisition from the identified person of permission information indicating that the viewer is permitted to view the identified person.

4. The information processing apparatus according to claim 3, wherein the at least one processor is configured to execute the instructions to:
receive an input of the request information indicating a wish to view a specified image including the identified person; and
delete the retouch for the person area in the specified image, in response to acquisition from the identified person of permission information indicating that the viewer is permitted to view the specified image.

5. The information processing apparatus according to claim 1, wherein the at least one processor is configured to execute the instructions to:
register the identified person and a consenter who consents to inputted content received from the identified person, in association with each other, and register the viewer and a consenter who consents to inputted content received from the viewer, in association with each other;
transmit the inputted content to a corresponding one the consenters, in response to reception of an input from the identified person or the viewer; and
enable the inputted content received from the identified person or the viewer, in response to reception of consent by the consenter.

6. An information processing method comprising:
adding or deleting a retouch for a person area including a predetermined part of a person in an image;
identifying a person corresponding to the person area, by using the person area;
determining whether or not a viewer who views the image is permitted to view the identified person identified by using the person area;
deleting the retouch for the person area, in response to a determination that the viewer is permitted to view the identified person; and
adding the retouch for the person area, in response to a determination that the viewer is not permitted to view the identified person.

7. A non-transitory recording medium on which a computer program that allows a computer to execute an information processing method is recorded, the information processing method including:
adding or deleting a retouch for a person area including a predetermined part of a person in an image;
identifying a person corresponding to the person area, by using the person area;
determining whether or not a viewer who views the image is permitted to view the identified person identified by using the person area;
deleting the retouch for the person area, in response to a determination that the viewer is permitted to view the identified person; and
adding the retouch for the person area, in response to a determination that the viewer is not permitted to view the identified person.
